(19) United States
(12) Patent Application Publication
(10) Pub. No.: US 2026/0349838 A1
(43) Pub. Date: Nov. 5, 2026

(54) LOAD DISTRIBUTION DEVICE, LOAD DISTRIBUTION SYSTEM, LOAD DISTRIBUTION METHOD, AND LOAD DISTRIBUTION PROGRAM

(71) Applicant: NTT, Inc., Tokyo (JP)

(72) Inventor: Yoshito ITO, Musashino-shi, Tokyo (JP)

(21) Appl. No.: 19/121,214

(22) PCT Filed: Oct. 26, 2022
(86) PCT No.: PCT/JP2022/039903

§ 371 Date: Apr. 15, 2025

(51) Int. Cl. G06F 9/50

(52) U.S. Cl. CPC G06F 9/5094; G06F 9/5083

(57) ABSTRACT

A request distribution part of a distribution device that distributes requests among servers, the request distribution part configured to: form a maximum efficiency group of servers and a change-permitted group of servers, each of the maximum efficiency group of servers being assigned a quantity of requests that results in a peak value of the power efficiency, each of the change-permitted group of servers being assigned a quantity of requests that fails to result in the peak value of the power efficiency; determine a distribution ratio for distributing the requests among the servers on a per-group basis; and after performing distribution among the servers with the determined distribution ratio, when a quantity of the requests varies by a variation quantity, reflect the variation quantity to the quantities of the requests allocated to the servers belonging to the change-permitted group.

### CROSS-REFERENCE TO RELATED APPLICATIONS

This is a National Stage Application of PCT Application No. PCT/JP2022/039903, filed on Oct. 26, 2022. The disclosure of the prior application is considered part of the disclosure of this application, and is incorporated in its entirety into this application.

### BACKGROUND

### Technical Field

The present invention relates to a load distribution device, a load distribution system, a load distribution method, and a load distribution program.

### Background Art

Various schemes have been proposed as a load distribution system for distributing received requests (or tasks) to any of a plurality of request processing parts (servers or CPUs).

Non-Patent Literature 1 describes the following two schemes as load balancers for distributing requests.
Static distribution scheme: Round Robin (RR), which is a representative policy, (statically) selects distribution destinations in order in a predetermined ratio.
Dynamic distribution scheme: A distribution ratio is dynamically changed for execution based on information such as the number of connections of distribution destinations, the number of clients, an amount of data communication, and a CPU use rate.

Non-Patent Literature 2 proposes Peak Efficiency Aware Scheduling (PEAS) having the following components.
Local Energy Efficiency Profiler (LEEP) dynamically measures the power efficiency of each server.
Global Scheduler, based on the power efficiencies acquired from LEEP, distributes requests to servers in order from the server with the highest power efficiency up to a resource use rate corresponding to the maximum efficiency (maximum power efficiency) of the server.

Non-Patent Literature 3 proposes Per Application Class Turbo Controller (PACT), which reduces power consumption even in a data center with a high use rate using the following two components. Note that App priority class (Per Application Class) is “latency sensitive” or “best-effort”.
“CPU Jailing” creates a CPU core allocation group and assumes that it operates with a low power consumption setting in “best-effort”.
“Turbo Control” dynamically executes V/F control and allocates more CPU cores to “latency sensitive” as a countermeasure to burst.

### PRIOR ART LITERATURE

### Non-Patent Literature

[Non-Patent Literature 1] Fujitsu, “Introduction to load distribution—3rd request distribution function (1/2),” [online], [Retrieved Oct. 18, 2022], 2006.12.19, Internet <URL: https://www.fujitsu.com/jp/products/network/security-bandwidth-control-load-balancer/ipcom/material/data/1/3.html>
[Non-Patent Literature 2] D. Wong, “Peak Efficiency Aware Scheduling for Highly Energy Proportional Servers,” [online], [Retrieved Oct. 18, 2022], 2016 ACM/IEEE 43rd Annual International Symposium on Computer Architecture (ISCA), 2016, pp. 481-492, doi: 10.1109/ISCA.2016.49, Internet <URL: https://ieeexplore.ieee.org/document/7551416>
[Non-Patent Literature 3] Kostis Kaffes, Dragos Sbirlea, Yiyan Lin, David Lo, and Christos Kozyrakis, “Leveraging application classes to save power in highly-utilized data centers,” [online], [Retrieved Oct. 18, 2022], In Proceedings of the 11th ACM Symposium on Cloud Computing (SoCC '20). Association for Computing Machinery, New York, NY, USA, 134-149, Internet <URL: https://doi.org/10.1145/3419111.3421274>

### SUMMARY OF THE INVENTION

### Problems to Be Solved by the Invention

In the conventional art such as Non-Patent Literatures 1 to 3, when the request arrival rate increases or decreases due to a demand fluctuation, the operation points of resource use rates of all the servers fluctuate, and the power efficiency of all the servers deteriorates. Therefore, the conventional arts perform the processing in an inefficient resource use rate range, resulting in an increase in the power consumption.

In view of this, a main object of the present invention is to operate a request processing part so that power efficiency increases by addressing demand fluctuations.

### Solution to Problem

In order to solve the problem, a load distribution device of the present invention has the following features.

An aspect of the present invention is a load distribution device including:
an information storage part; and
a distribution part,
wherein the information storage part includes one or more processors and is configured to store, as ratio determination information for determining a distribution ratio for distributing a plurality of requests among a plurality of request processing parts, power efficiency information indicative of power efficiency in processing each allocation share of the plurality of requests, the power efficiency information including a quantity of requests to be allocated that results in a peak value of the power efficiency; and
wherein the distribution part includes one or more processors and is configured to, based on the ratio determination information read from the information storage part:
   form a maximum efficiency group of request processing parts and a change-permitted group of request processing parts, each of the maximum efficiency group of request processing parts being assigned the quantity of requests to be allocated that results in the peak value of the power efficiency, each of the change-permitted group of request processing parts being assigned a quantity of requests that fails to result in the peak value of the power efficiency;
   determine the distribution ratio for distributing the plurality of requests among the plurality of request processing parts in such a manner that, for each of the plurality of request processing parts, an allocation share to be allocated to the request processing part is determined based on the group to which the request processing part belongs; and
   after performing distribution among the plurality of request processing parts with the determined distribution ratio, when a quantity of the plurality of requests varies by a variation quantity, reflect the variation quantity to the quantities of the requests allocated to the request processing parts belonging to the change-permitted group.

### Advantageous Effects of Invention

According to the present invention, it is possible to operate the request processing part so that the power efficiency increases by addressing demand fluctuations.

### BRIEF DESCRIPTION OF THE DRAWINGS

FIG. 1 is a configuration diagram of a load distribution system related to the present embodiment.

FIG. 2 is a detailed configuration diagram of the load distribution system related to the present embodiment.

FIG. 3 is a hardware configuration diagram of each device of the load distribution system related to the present embodiment.

FIG. 4 is a table showing the content stored in a collected data storage part related to the present embodiment.

FIG. 5 is a graph showing a relationship between CPU use rate and power efficiency from the information of the table of FIG. 4 related to the present embodiment.

FIG. 6 is a graph showing another example related to the present embodiment, depicted in the graph format of FIG. 5.

FIG. 7 is a flowchart illustrating the processing of a data collecting part related to the present embodiment.

FIG. 8 is a flowchart illustrating the processing of a data analysis part related to the present embodiment.

FIG. 9 is a graph showing relationships of power characteristic information related to the present embodiment.

FIG. 10 is a flowchart illustrating the processing of a request distribution part related to the present embodiment.

FIG. 11 is an explanatory diagram showing a ratio of distribution to servers related to the present embodiment.

FIG. 12 is an explanatory diagram showing a ratio for distribution to servers when addressing a case where the quantity of current RPS slightly increases from the state of FIG. 11 related to the present embodiment.

FIG. 13 is an explanatory diagram showing a ratio for distribution to servers when addressing a case where the quantity of current RPS greatly increases from the state of FIG. 11 related to the present embodiment.

FIG. 14 is an explanatory diagram showing a ratio for distribution to servers when addressing a case where the quantity of current RPS slightly decreases from the state of FIG. 11 related to the present embodiment.

FIG. 15 is an explanatory diagram showing a ratio for distribution to servers when addressing a case where the quantity of current RPS greatly decreases from the state of FIG. 11 related to the present embodiment.

### MODES FOR CARRYING OUT THE INVENTION

Hereinafter, an embodiment of the present invention will be described in detail with reference to the drawings.

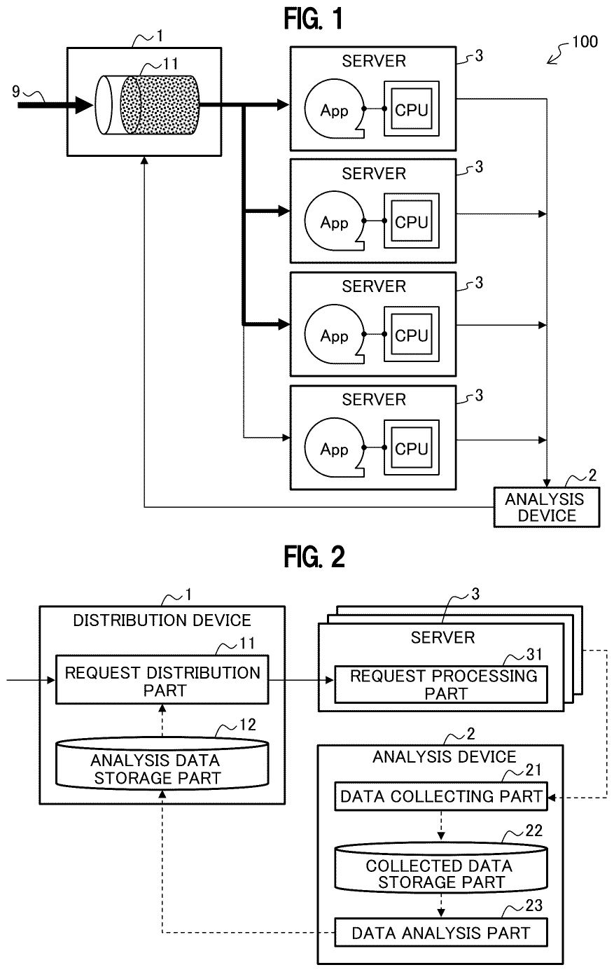

FIG. 1 is a configuration diagram of a load distribution system 100.

The load distribution system 100 includes a distribution device (load distribution device) 1, an analysis device 2, and servers 3, which are connected via a network.

The distribution device 1 distributes received requests (or tasks; hereinafter referred to as “received requests 9”) among the servers 3. The received requests 9 are stored in a queue of a request distribution part 11, and sequentially read from the queue and distributed to the servers 3. As the distribution device 1 dynamically controls the ratio for distributing the requests, the distribution device 1 can be configured with less implementation through extension based on the function of an existing Layer 4 (L4) load balancer.

The analysis device 2 collects from each server 3 information to be used by the distribution device 1 to determine the ratio for distributing the requests, and analyzes the information. For example, the analysis device 2 analyzes power characteristic information of each server 3 and notifies the distribution device 1 of the analysis result. On the other hand, as the distribution device 1 is able to determine the ratio for distributing the requests based on the information communicated from the analysis device 2, the distribution device 1 need not directly monitor the resource use rate per server 3. Therefore, the distribution device 1 has a small overhead through simple distribution processing.

The servers 3 are distribution destinations of the requests from the distribution device 1. The server 3 includes a CPU for processing its distributed requests and an application (App) operating on the CPU. In FIG. 1, four Web servers are operating as the distribution destination servers 3, and each Web server processes HTTP requests allocated by the distribution device 1.

Hereinafter, an expression “requests are distributed to the server 3” means, more accurately, that the requests are distributed to request processing parts 31 (FIG. 2) in the servers 3. Further, the resource (for example, CPU) of the server 3 means a resource used for an operation of the request processing part 31 in the server 3. Hereinafter, for the sake of simplicity of description, an exemplary configuration in which one CPU is present in one server 3 is presented. However, the present embodiment is also applicable to a configuration in which a plurality of request processing parts 31 (a plurality of CPUs) are present in one server 3.

The distribution device 1 can be applied to, for example, the following devices.
A (L4 or L7) load balancer, which is a distribution device 1, determines the ratio for distribution to Web servers based on a request arrival rate (Requests Per Second (RPS) or the like) of the received requests 9 (HTTP requests) (details will be described later in the present specification).
A Layer 2 switch (L2SW), which is a distribution device 1, determines the ratio for distribution to CPUs or processing circuits based on a packet arrival rate of the received packets.
A (L4 or L7) load balancer, which is a distribution device 1, is deployed among the servers 3 and determines the ratio for distribution to Packet Data Network Gateways (P-GW) based on the packet arrival rate of the received packets.
A task scheduler, which is a distribution device 1, is deployed in a server 3 and determines the ratio for distribution to CPUs or processing circuits based on the packet arrival rate of the received packets.

As comparative examples, two types of schedulers below have been implemented in the kernel of conventional Linux (registered trademark).
Standard scheduler: Stop-Task, Deadline-Task, Realtime-Task, Fair-Task, Idle-Task. This standard scheduler performs task execution control according to priority.
Arm (registered trademark) specialized scheduler: Capacity Aware, Power Aware. This Arm-specialized scheduler performs task execution control assuming a heterogeneous physical core configuration (for example, big.LITTLE).

However, as any comparative example fails to take into account the power efficiency, it fails to cause an operation to operate at an operation point optimal with respect to the resource use rate. The Arm-specialized Power Aware scheduler is intended to keep the CPU frequency to a lowest frequency on the premise of big. LITTLE and fails to take the power efficiency into account.

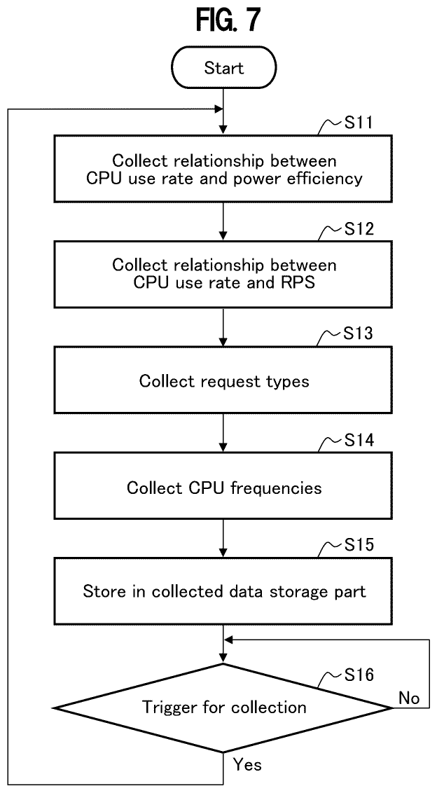

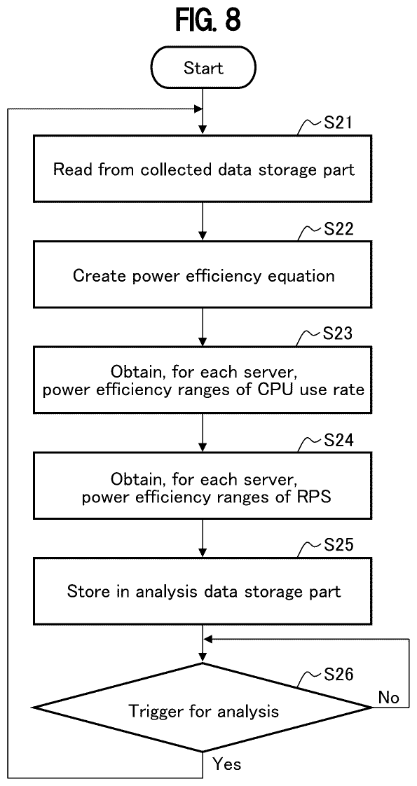

In view of this, a task scheduler acting as the distribution device 1 of the present embodiment constitutes the request distribution part 11 such that an operation is performed at an operation point optimal with respect to the resource use rate and the demand fluctuations thereof (see FIG. 7 for details).

FIG. 2 is a detailed configuration diagram of the load distribution system 100.

The server 3 includes the request processing part 31. Note that the analysis device 2 and the server 3 may be configured as separate devices or may be included in the same device.

The request processing part 31 processes received requests 9 allocated by the distribution device 1.

The analysis device 2 includes a data collecting part 21, a collected data storage part 22, and a data analysis part 23.

The data collecting part 21 collects per-server 3 power characteristic information before or during request processing of the server 3, and stores the result of collection in the collected data storage part 22. The power characteristic information is data indicative of power efficiency with respect to the number of requests, which data is calculated based on the number of requests processed by each server 3 and the power consumption required for processing the requests (see FIG. 4 for details).

The data analysis part 23, based on the collected power characteristic information of each server 3, analyzes information indicative of power efficiency in processing each allocation share of the requests 9, the information including a quantity of received requests 9 to be allocated that results in a peak value of the power efficiency, and causes an analysis data storage part 12 to store the result of the analysis as ratio determination information (information for determining the distribution ratio).

The distribution device 1 includes the request distribution part (distribution part) 11 and an analysis data storage part (information storage part) 12. Note that the analysis data storage part 12 may be configured to be located outside the distribution device 1 and accessible via a network.

The analysis data storage part 12 stores the ratio determination information communicated from the data analysis part 23 of the analysis device 2 as analysis data of the data analysis part 23.

The request distribution part 11 determines a distribution ratio for distributing the received requests 9 among the servers 3. For the distribution ratio, a consideration is made as to how the highest power efficiency is achieved and how a fluctuation in the quantity of the received requests 9 can be easily handled by distributing the requests to which resource at which proportion with respect to the request arrival rate. The request distribution part 11 distributes the requests among the servers according to the distribution ratio.

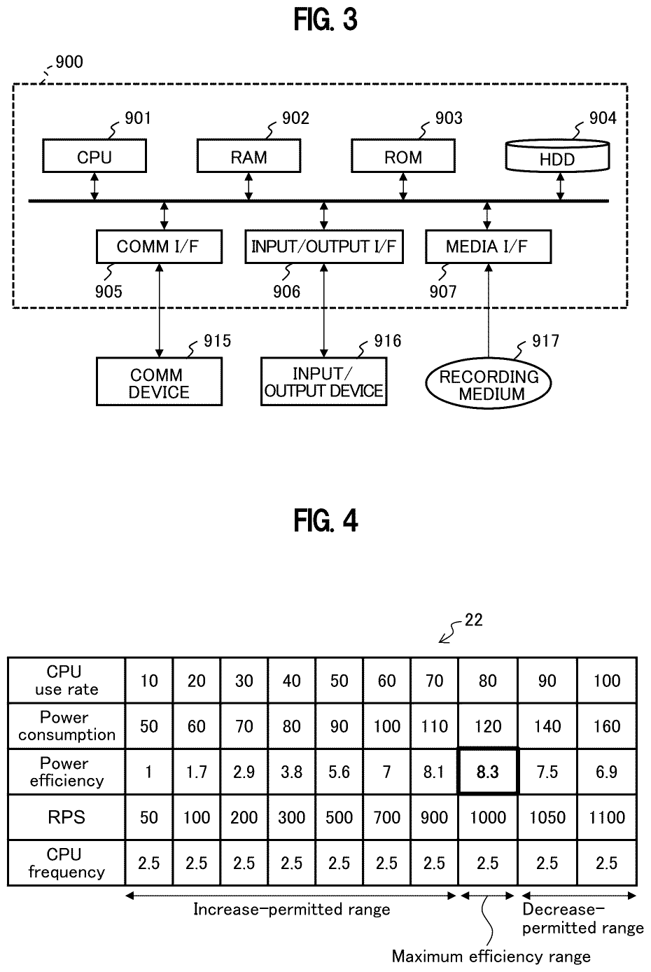

FIG. 3 is a hardware configuration diagram of each device of the load distribution system 100.

Each device (distribution device 1, analysis device 2, or server 3) of the load distribution system 100 is configured as a computer 900 including a CPU 901, a RAM 902, a ROM 903, an HDD 904, a communication I/F 905, an input/output I/F 906, and a media I/F 907.

The communication I/F 905 is connected to an external communication device 915. The input/output I/F 906 is connected to an input/output device 916. The media I/F 907 reads and writes data from and to a recording medium 917. Furthermore, the CPU 901 controls each component by executing a program (also referred to as an application or app as an abbreviation therefor) read into the RAM 902. This program can also be distributed through a communication line or recorded on the recording medium 917 such as a CD-ROM to be delivered.

FIG. 4 is a table showing the content stored in the collected data storage part 22.

The table in FIG. 4 stores: a CPU use rate (%), which is a resource use rate of the server 3; a power consumption (W) of the server 3; a power efficiency (Request/W) of the server 3; requests per second (RPS; the number of processed requests/sec), which is a processing amount of the server 3; and a CPU frequency (GHz) of the server 3, associated with one another.

The power efficiency of the server 3 is the number of requests that can be processed per 1 W (Watt) and, generally, is processing performance per power consumption. The CPU frequency of the server 3 is an operation frequency.

Hereinafter, description will be given on the assumption that processing of any request has substantially the same load amount and it is not necessary to distinguish between the requests. On the other hand, the requests may be classified into, for example, any of: a request with a high load, a request with a medium load, and a request with a small load, as a request type, and the number of requests may be counted for each request type.

Furthermore, as shown in the table of FIG. 4, since the power consumption of the server is generally non-linear with respect to the CPU use rate, the power efficiency of the execution of the request does not simply increase with respect to the CPU use rate.

The data collecting part 21 collects the information in the table shown in FIG. 4 as the per-server 3 power characteristic information. Here, the table in FIG. 4 is completed with only one table in a configuration (homogeneous configuration) in which a plurality of servers 3 have the same processing performance. On the other hand, in a configuration (heterogeneous configuration) in which the plurality of servers 3 have different processing performances, it is necessary to prepare a table for each server 3.

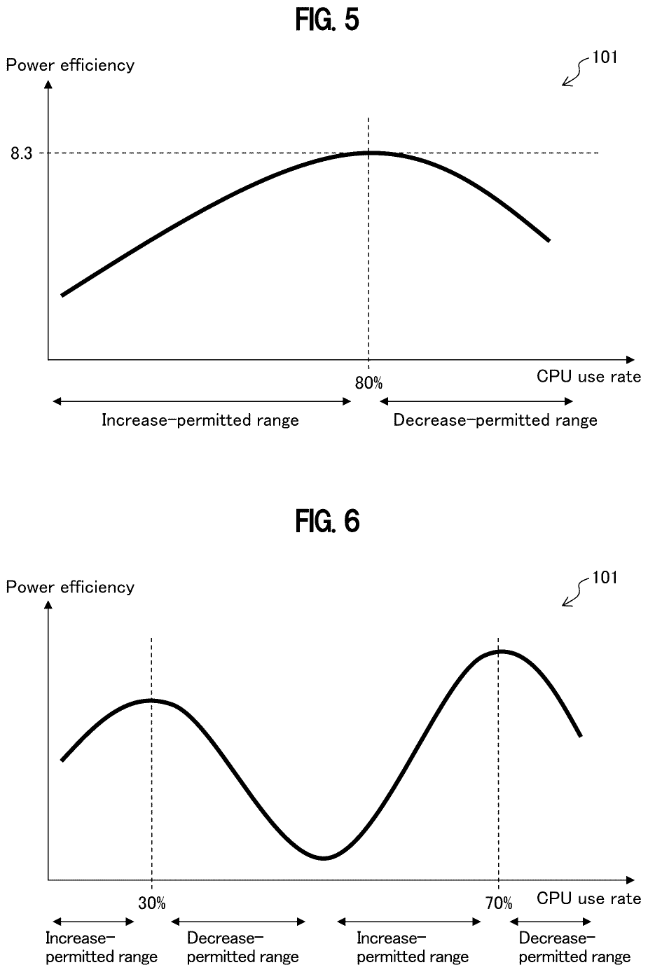

Here, power efficiency ranges (maximum efficiency range, increase-permitted range, and decrease-permitted range) to which the columns of the table belong are noted below the table of FIG. 4. The power efficiency ranges are information for classifying each server 3 into power efficiency groups (maximum efficiency group, increase-permitted group, and a decrease-permitted group). Hereinafter, details of the power efficiency ranges will be described with reference to FIG. 5.

FIG. 5 is a graph showing a relationship between the CPU use rate and the power efficiency based on the information of the table shown in FIG. 4. In this graph, there is a peak value of power efficiency=8.3 at a CPU use rate=80% (in FIG. 4, a cell value of “8.3” is emphasized).

The “power efficiency range” is the following classification information indicative of a trend of power efficiency in a range to which an index (in this case, CPU use rate) belongs.
The maximum efficiency range is a range in which the maximum power efficiency is exhibited (a peak value exists) in the server 3 at an index value belonging to the range.
The increase-permitted range is a range in which the maximum power efficiency is not exhibited in the server 3 at index values belonging to the range but the power efficiency increases due to an increase in the index value. For example, the increase-permitted range in FIG. 5 is set to a range with a lower CPU use rate (a range in which the graph has a positive gradient) than the CPU use rate in the maximum efficiency range. Thus, as the CPU use rate increases, the power efficiency increases because the CPU use rate approaches the maximum efficiency range.
The decrease-permitted range is a range in which the maximum power efficiency is not exhibited in the server 3 at index values belonging to the range but the power efficiency increases when the index value decreases. For example, the decrease-permitted range in FIG. 5 is set to a range with a higher CPU use rate (a range in which the graph has a negative gradient) than the CPU use rate in the maximum efficiency range. Thus, as the CPU use rate decreases, the power efficiency increases because the CPU use rate approaches the maximum efficiency range.

FIG. 6 is a graph showing another example depicted in the form of the graph shown in FIG. 5. In this graph, peak values of the graph exist as local maximum values at two points (CPU use rate=30% and 70%).
The maximum efficiency range is set at two places (CPU use rate=30% and 70%). That is, when there are a plurality of peak values of the graph, the term “maximum efficiency” is read as “local maximum efficiency”.
The increase-permitted range is also set at two places (a range with a CPU use rate smaller than 30% and a range with a CPU use rate smaller than 70%).
The decrease-permitted range is also set at two places (a range with a CPU use rate higher than 30% and a range with a CPU use rate higher than 70%).

FIG. 7 is a flowchart illustrating the processing of the data collecting part 21.

The data collecting part 21 collects (S11) the relationship between the CPU use rate and the power efficiency for each server 3. Collection processing of S11 is performed in the following procedure, for example, by using a load tool or actual requests.
(Procedure 1) Requests are transmitted to each server 3 in a range of 0% to 100% of CPU use rate by using a load tool, and data of the number of requests processed is collected based on a log of the Web server and data of power consumption is collected with an Intelligent Platform Management Interface (IPMI) or a power meter.
(Procedure 2) Information on the correspondence between the number of requests processable per 1 W and the CPU use rate, collected in procedure 1, is stored as correspondence information between “CPU use rate” and “power efficiency” in the table of FIG. 4. With this, the resource use rate for maximum efficiency can be calculated and can be applied also to a heterogeneous configuration.

For the resource use rate collected in S11, not only the CPU use rate, but also many resource use rates such as a Graphics Processing Unit (GPU) use rate and a memory use rate can be handled in a multi-dimensional manner.

The data collecting part 21 collects (S12) relationship between the CPU use rate and the RPS by using the data collected in S11. The information collected in S12 is stored as correspondence information between the “CPU use rate” and the “RPS” in the table of FIG. 4. With this, as the CPU use rate (resource use rate) is not required for the distribution logic of the request distribution part 11, it is not necessary to monitor the resource use rate of a distribution destination server 3.

The data collecting part 21 may collect (S13) data for each request type for the collection processing of S11 and S12. In this case, the table of FIG. 4 is generated for each combination of the number of servers 3 and the number of request types.

Further, the data collecting part 21 may, when collecting data in S11, also collect (S14) a CPU frequency (operation frequency of the resource) of each server 3 and store the data and the CPU frequency associated with each other in the table of FIG. 4.

The data collecting part 21 associates the pieces of information collected in S11 to S14 and stores (S15) the information in the collected data storage part 22 as the power characteristic information for each server 3 shown in FIG. 4. The collected data storage part 22 is a database accessible from the distribution device 1.

The data collecting part 21 waits (S16: No) until a next trigger of data collection processing, and starts the processing of S11 again when the data collection processing is triggered (S16: Yes). Examples of the trigger of the data collection processing include any of the following. With this, it is possible to update the data stored in the collected data storage part 22 following changes in the power efficiency.
Regular execution: The processing of S11 starts every preset time interval (for example, one week).
Detection of change in power efficiency: For example, as setting information of the server 3 and environment information (temperature change or the like) around the server 3, a power policy, C-state, HyperThreading, fan control, power cap, and thermal throttling are collected to address the changes in the power efficiency due to temperature changes or the like. Then, when a change occurs from the information collected in the past, the processing of S11 is started.

FIG. 8 is a flowchart illustrating the processing of the data analysis part 23.

The data analysis part 23 reads (S21) the power characteristic information collected by the processing of FIG. 5 from the collected data storage part 22.

The data analysis part 23 formulates the power efficiency as a function of the CPU use rate by using regression analysis or the like on the power characteristic information read in S21 to generate a polynomial, to create a power efficiency equation indicating power efficiency with respect to the CPU use rate (S22). The power efficiency equation is an equation showing an approximate line of the graph lines shown in FIGS. 5 and 6. With this, it is possible to set an operation point at which the power efficiency is increased as much as possible even for a server 3 operating at a CPU use rate that does not maximize efficiency.

The data analysis part 23 obtains the power efficiency ranges with respect to the CPU use rate for each server 3 by using the power characteristic information read in S21 and the power efficiency equation created in S22, as described with reference to FIGS. 5 and 6 (S23). When data are collected for each request type in S13, the data analysis part 23 may correct the calculation result of S23 for each combination of the server 3 and the request type.

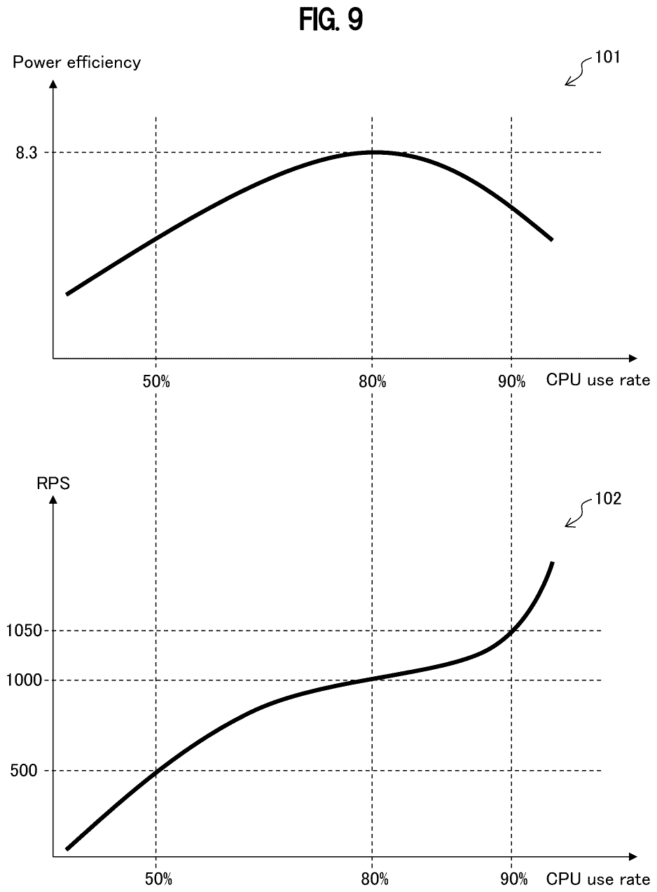

The data analysis part 23 obtains the power efficiency ranges of RPS for each server 3 based on the power efficiency ranges of CPU use rate obtained in S23 and determines (S24; details are shown in FIG. 9) the obtained power efficiency ranges of RPS and the power efficiencies in the ranges as ratio determination information. With this, as real-time metrics such as a CPU use rate for each server 3 are not required for the ratio determination information, it is possible to simplify the processing of determining the distribution ratio to avoid unnecessary power consumption due to collection of the metrics.

The data analysis part 23 transmits the ratio determination information to the distribution device 1 to cause the analysis data storage part 12 in the distribution device 1 to store (S25) the ratio determination information.

The data analysis part 23 waits (S26: No) until the next trigger of data analysis processing and starts the processing of S21 again when the data analysis processing is triggered (S26: Yes). Examples of the trigger of the data analysis processing includes when the per-server 3 power characteristic information stored in the collected data storage part 22 is updated due to data collection processing being triggered (S16: Yes).

FIG. 9 is a graph showing a relationship of the power characteristic information.

The first graph 101 and the second graph 102 are generated from the power characteristic information in the collected data storage part 22 shown in FIG. 4 or the like.

In the first graph 101, the horizontal axis represents the CPU use rate and the vertical axis represents the corresponding power efficiency. The data analysis part 23 calculates (S23) the below-listed power efficiency ranges of CPU use rate from the first graph 101.
A range of CPU use rate=80%, which corresponds to a peak value of power efficiency, which is obtained according to: maximum efficiency range of CPU use rate =peak value of power efficiency=8.3
Increase-permitted range of CPU use rate=a range of CPU use rate (for example, 50%) lower than the maximum efficiency range. That is, a range where the gradient of the graph line shown according to the power efficiency equation of S22 is positive.
Decrease-permitted range of CPU use rate=range of CPU use rate higher than the maximum efficiency range (for example, 90%). That is, a range where the gradient of the graph line shown according to the power efficiency equation of S22 is negative.

In the second graph 102, the horizontal axis represents the CPU use rate, and the vertical axis represents the corresponding RPS. The data analysis part 23 calculates (S24) the below-listed power efficiency ranges RPS based on the second graph 102.
A range of RPS=1000, which corresponds to a maximum efficiency range of RPS=maximum efficiency range of CPU use rate (=80%)
Increase-permitted range of RPS=a range of RPS (for example, 500) corresponding to the increase-permitted range of CPU use rate (for example, 50%)
Decrease-permitted range of RPS=a range of RPS (for example, 1050) corresponding to the decrease-permitted range of CPU use rate (for example, 90%)

Like this, the data analysis part 23 creates the ratio determination information such that, in addition to the maximum efficiency range where a specific CPU use rate=80% is maintained, an increase or a decrease of RPS in a direction approaching the maximum efficiency range is allowed. On the other hand, in the distribution scheme described in Non-Patent Literature 1, distribution is merely to be preferentially performed to a server with a low CPU use rate.

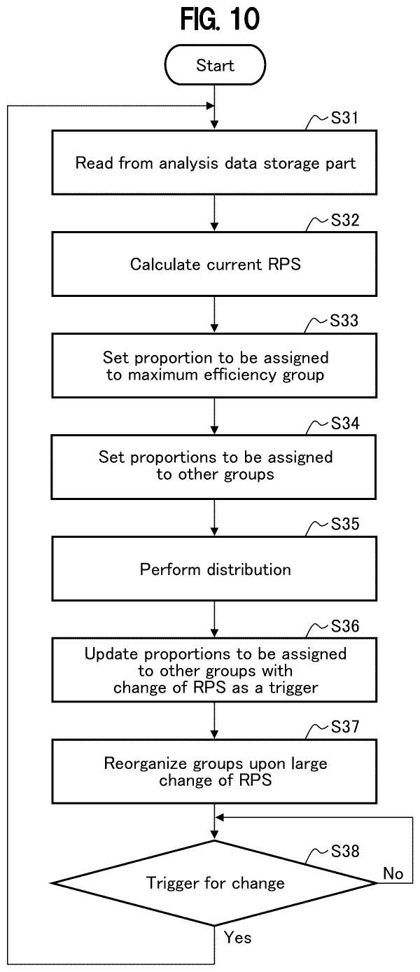

FIG. 10 is a flowchart illustrating the processing of the request distribution part 11.

The request distribution part 11 reads (S31) the ratio determination information stored in S25 from the analysis data storage part 12. The analysis data storage part 12 stores, as ratio determination information for determining a distribution ratio for distributing received requests 9 among a plurality of servers 3, information indicative of power efficiency in processing each allocation share of the requests 9, the information including a quantity of received requests 9 to be allocated that results in a peak value of the power efficiency.

The request distribution part 11 calculates (S32) a current RPS from the number of HTTP requests per second of the received requests 9.

The request distribution part 11, based on the ratio determination information read from the analysis data storage part 12, forms: a maximum efficiency group in which a quantity to be allocated that results in a peak value of the power efficiency is allocated to each server 3; and a change-permitted group in which a quantity to be allocated that fails to result in a peak value of the power efficiency is allocated to each server 3, by the later-described processing regarding S33 and S34. Then, the request distribution part 11 determines the distribution ratio for distributing the received requests 9 among the servers 3 belonging to each group. Note that at least one group of the increase-permitted group and the decrease-permitted group is defined as a “change-permitted group” that permits changes in the distribution ratio.

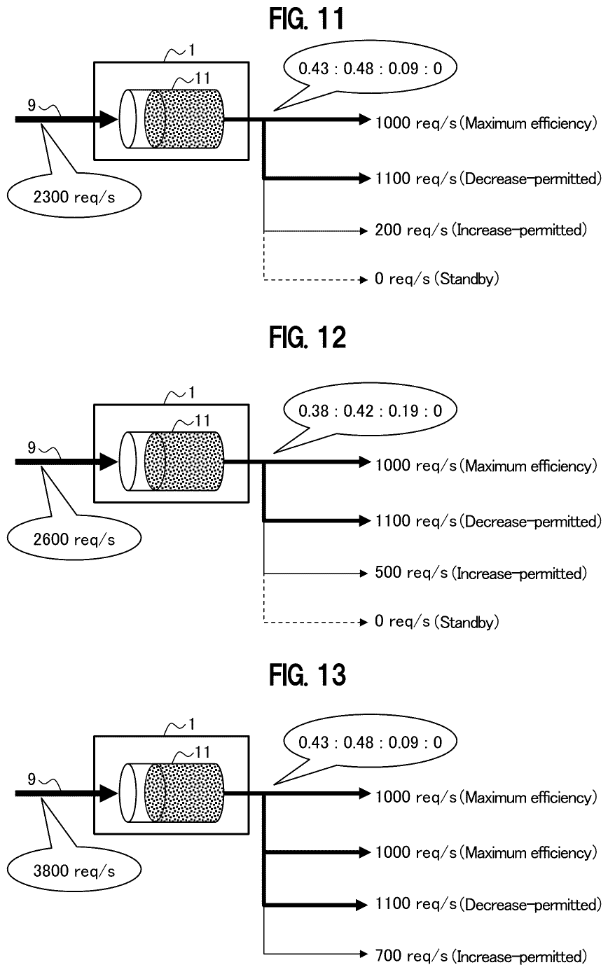

The request distribution part 11 references the ratio determination information to select servers 3 belonging to the maximum efficiency group and sets (S33; details are shown in FIG. 11) an assigned proportion of the current RPS for each selected server 3. It is preferable that the servers 3 belonging to the maximum efficiency group be selected such that a server 3 whose maximum efficiency indicated by the maximum efficiency range is high is prioritized.

The request distribution part 11 references the ratio determination information to select, for each of the other groups (increase-permitted group and decrease-permitted group), at least one server 3 belonging to the group and sets (S34; details are shown in FIG. 11), for each selected server 3, an assigned proportion of the current (remaining) RPS which have not been distributed in S33.

Note that the request distribution part 11 may cause a server 3 to which no RPS has been allocated until S34 to belong to a standby group which is to be caused to transition to a power saving mode (for example, power OFF or Sleep). This makes it possible to improve the power efficiency of the entire system.

Furthermore, the request distribution part 11 may, using the current CPU frequencies of the servers 3, update the ratio for distributing RPS until S34. An example of the update processing is to, with respect to the distribution ratio set until S34, update the distribution ratio using the current CPU frequency on the assumption that the processable RPS increases in proportion to the CPU frequency.

The request distribution part 11 executes (S35) processing for distributing the received requests 9 among the request processing parts 31 of the servers 3 according to the RPS distribution ratio determined until S34. With this, as the request distribution part 11 does not need to individually determine a distribution destination for each request while executing the distribution and can be implemented based only on a distribution logic with a simple distribution ratio, an overhead of the distribution is small.

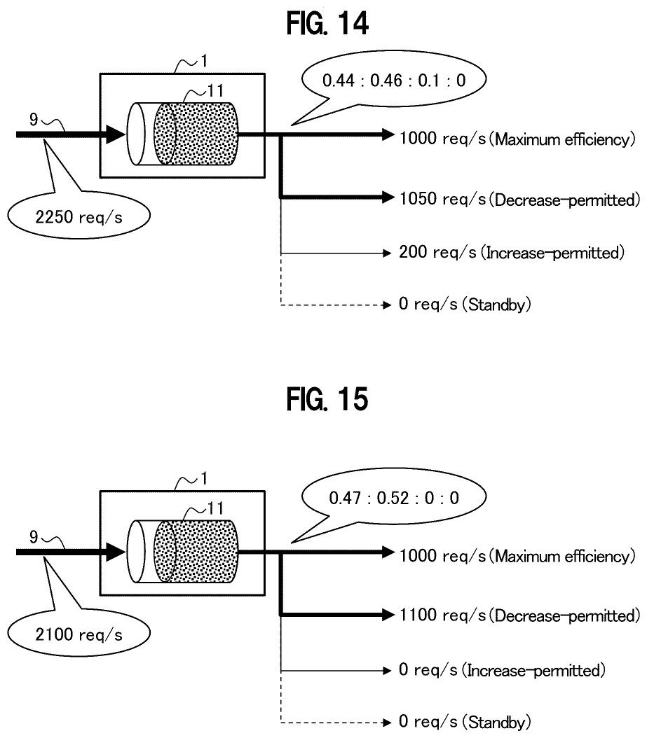

Here, when the current RPS (S32) of the received request 9 changes, the request distribution part 11 updates (S36; the details are shown in FIGS. 12 and 14) the distribution ratio for the servers 3 belonging to the other groups (increase-permitted group and decrease-permitted group) set in S34.

That is, in S36, the request distribution part 11, after performing the distribution for the server 3 with the determined distribution ratio, when the number of the received requests 9 varies, reflects the amount of variation to the quantities of allocation shares allocated to the servers 3 in the change-permitted group, as illustrated in the following (1) and (2).
(1) The request distribution part 11 forms an increase-permitted group in which an allocation quantity in an increase-permitted range is distributed among servers 3 as a change-permitted group, and when the quantity of received requests 9 increases, distributes the increase among the servers 3 in the increase-permitted group. To this end, the analysis data storage part 12 creates an increase-permitted range indicative of a range of a first allocation quantity such that the power efficiency is improved by increasing an allocation quantity to be greater than the first allocation quantity and includes the increase-permitted range in the ratio determination information.
(2) The request distribution part 11 forms a decrease-permitted group in which an allocation quantity in a decrease-permitted range is distributed among servers 3 as a change-permitted group, and when the quantity of received requests 9 decreases, performs distribution such that the decrease is deleted from the servers 3 in the decrease-permitted group. To this end, the analysis data storage part 12 creates a decrease-permitted range indicative of a range of a second allocation quantity such that power efficiency is improved by reducing an allocation quantity to be less than the second allocation quantity and includes the decrease-permitted range in the ratio determination information.

With this, the request distribution part 11 absorbs the change in the current RPS with other groups (increase-permitted group and decrease-permitted group) without changing the affiliation relationship of each server 3 to a respective power efficiency group, and the following effects can be obtained.
A situation where all the distribution destinations operate at points deviating from maximum efficiency points is prevented, so that the power efficiency is improved.
It is not necessary to recalculate and reset the distribution ratio for the total number of distribution destinations, so that the overhead of the distribution logic is reduced.

Furthermore, when a large change in the current RPS cannot be absorbed only by the processing of updating the distribution ratio in S36, the entirety of power efficiency groups is reorganized in order to address the large change in RPS (S37; details are shown in FIG. 13).

The request distribution part 11 waits (S38: No) until the next trigger of changing the distribution ratio and starts processing of S31 when a change of the distribution ratio is triggered (S38: Yes). The change trigger of the distribution ratio is, for example, when the ratio determination information stored in the analysis data storage part 12 is updated by the data analysis processing being triggered (S26, Yes).

In this way, the request distribution part 11 operates as a dynamic distribution scheme according to the triggers of changing the distribution ratio, and each server 3 operates with high power efficiency according to the quantity of current RPS.

FIG. 11 is an explanatory diagram showing an example of a distribution ratio for servers.

The request distribution part 11 calculates (S32) a current RPS=2300 [req/s] of the received requests 9. The request distribution part 11 causes the four servers 3 to belong to respective power efficiency ranges and allocates the current RPS as follows. Note that the first, second, . . . servers 3 are shown in order from the top of FIG. 11.
A maximum efficiency group is formed with the first server 3, and an RPS=1000 corresponding to the maximum efficiency range of RPS is assigned. Note that “assigned proportion for server 3”=“RPS allocated to server 3”/“current RPS”. For example, an assigned proportion of 1000/2300=0.43 is set for the first server 3.
A decrease-permitted group is formed with the second server 3, and an RPS=1100 included in the decrease-permitted range of RPS is assigned.
An increase-permitted group is formed with the third server 3, and an RPS=200 included in the increase-permitted range of RPS is assigned.
A standby group is formed with the fourth server 3, and the power saving mode is set without assigning an RPS.

Note that the number of servers 3 belonging to the maximum efficiency group is 1 according to the following formula.

“Current RPS=2300”/“RPS =1000 corresponding to the maximum efficiency range”=2.3 servers→2 servers (round down after decimal point), and 2 servers−1 server (for other groups)=1 server.

FIG. 12 is an explanatory diagram showing the ratio for distribution to the servers when addressing a case where the quantity of the current RPS slightly increases (2300→2600) from the state shown in FIG. 11.

Here, the request distribution part 11 increases the RPS=200 of the third server 3 of the increase-permitted group to an RPS=500, updating (S36) the assigned proportion for the server 3. That is, an increase (+300) of the current RPS is absorbed by only the increase-permitted group=the third server 3. With this, the affiliation relationship of each server 3 to a respective power efficiency group is not changed and the power efficiency of the entire system is improved after updating in S36.

FIG. 13 is an explanatory diagram showing the ratio for distribution to the servers when addressing a case where the quantity of the current RPS greatly increases (2300→3800) from the state shown in FIG. 11.

Although the request distribution part 11 considers increasing the RPS=200 of the third server 3=increase-permitted group, the power efficiency will be degraded when the allocation share is increased to be greater than an RPS=1000, as shown in FIG. 9. That is, even for the server 3 belonging to the increase-permitted group, the range in which an increase is permitted is up to the increase-permitted range (RPS<1000).

Therefore, when the increase (+1500) in FIG. 13 is assigned only to the third server 3 (RPS=200), the server 3 gets assigned an RPS=1700, which exceeds the range of the increase-permitted range (RPS<1000).

In view of this, the request distribution part 11 reorganizes the entire power efficiency groups to address (S37) the large change in RPS.
Maximum efficiency groups are formed with the first and second servers 3, and an RPS=1000 corresponding to the maximum efficiency range of the RPS is assigned thereto.
A decrease-permitted group is formed with the third server 3, and an RPS=1100 included in the decrease-permitted range of RPS is assigned thereto.
An increase-permitted group is formed with the fourth server 3, and an RPS=700 included in the increase-permitted range of RPS is assigned thereto. This falls within the range of the increase-permitted range (RPS<1000).

FIG. 14 is an explanatory diagram showing the ratio for distribution to the servers when addressing a case where the quantity of the current RPS slightly decreases (2300→2250) from the state shown in FIG. 11.

Here, the request distribution part 11 decreases the RPS=1100 of the decrease-permitted group=the second server 3 to an RPS=1050, updating (S36) the assigned proportion for the server 3. That is, a decrease (−50) of the current RPS is absorbed by only the decrease-permitted group=the second server 3. With this, the affiliation relationship of each server 3 to a respective power efficiency group is not changed and the power efficiency of the entire system is improved after updating in S36.

FIG. 15 is an explanatory diagram showing the ratio for distribution to the servers when addressing a case where the quantity of the current RPS greatly decreases (2300→2100) from the state shown in FIG. 11.

Although the request distribution part 11 considers decreasing the RPS=1100 of the second server 3=decrease-permitted group, the power efficiency will be degraded when the allocation share is decreased to an RPS lower than the RPS=1000, as shown in FIG. 9. That is, even for the server 3 belonging to the decrease-permitted group, the range in which a decrease is permitted is down to the decrease-permitted range (RPS>1000).

Therefore, when the decrease (−200) in FIG. 15 is assigned only to the second server 3 (RPS=1100), the RPS of the server 3 gets assigned an RPS=900, which departs from the range of the decrease-permitted range (RPS>1000).

In view of this, the request distribution part 11 reorganizes the entire power efficiency groups to address the large change in RPS (S37).
A maximum efficiency group is formed with the first server 3, and an RPS=1000 corresponding to the maximum efficiency range of RPS is assigned thereto.
A decrease-permitted group is formed with the second server 3, and an RPS=1100 included in the decrease-permitted range of RPS is assigned thereto.
An increase-permitted group is formed with the third server 3, and an RPS=0 included in the increase-permitted range of RPS is assigned thereto. Note that, as at least one server 3 is required for the increase-permitted group, the power saving mode is not set even when the RPS is 0.
A standby group is formed with the fourth server 3, and the power saving mode is set without assigning the RPS.

As described above with reference to FIGS. 11 to 15, the request distribution part 11 uses different types of groups together such that at least one server 3 belongs to each of the maximum efficiency group, the decrease-permitted group, and the increase-permitted group, thereby operating the servers 3 with high power efficiency even when the RPS varies or does not vary.

On the other hand, in an environment in which a fluctuation situation of RPS is known in advance, such as a bank web service in which access is concentrated (quantity of RPS increases) in a lunch break, the request distribution part 11 may set the number of servers 3 in the maximum efficiency group and the decrease-permitted group to zero, and set one type of group configuration before lunch break such that the servers 3 belong only to the increase-permitted group. That is, the request distribution part 11 may form at least one group among the maximum efficiency group, the decrease-permitted group, and the increase-permitted group according to the situation.

### Effects

A distribution device 1 of the present invention is characterized in including:
an analysis data storage part 12 that stores, as ratio determination information for determining a distribution ratio for distributing received requests 9 among a plurality of servers 3, information indicative of power efficiency in processing each allocation share of the requests 9, the information including a quantity of received requests 9 to be allocated that results in a peak value of the power efficiency; and
a request distribution part 11 that, based on the ratio determination information read from the analysis data storage part 12,
forms a maximum efficiency group in which the quantity to be allocated that results in the peak value of the power efficiency is allocated to each server 3 and a change-permitted group in which a quantity to be allocated that fails to result in the peak value of the power efficiency is allocated to each server 3,
determines a distribution ratio for distributing the received requests 9 among the servers 3 belonging to each group, and
after performing distribution among the servers 3 with the determined distribution ratio, when the quantity of the received requests 9 varies, reflects the variation in the quantity to the quantities of allocation shares allocated to the servers 3 in the change-permitted group.

With this, the distribution device 1 selectively causes the servers 3 in the change-permitted group not operating at the maximum efficiency point to address a demand fluctuation of the received requests 9, preventing all the servers from operating deviating from an optimal point together. Thus, the distribution device 1 is capable of operating the request processing parts so as to increase the power efficiency while addressing the demand fluctuation.

Furthermore, the distribution device 1 is, as compared with the following comparative examples, capable of operating with high power efficiency and operating the distribution logic in a lightweight manner.
In the case of load balancer described in Non-Patent Literature 1, when the request arrival rate (task generation rate) varies, it is necessary to recalculate and reset the assigned proportions for all the servers, which is inefficient.
In the case of PEAS described in Non-Patent Literature 2, when the number of RPS is large compared to the frequency at which the resource use rate is updated, even though requests enough to result in the resource use rate maximizing efficiency have already actually been allocated, this situation is not detectable because the resource use rates have not been updated yet, and requests exceeding those resulting in the resource use rate maximizing efficiency may be distributed, resulting in low efficiency. Furthermore, as the distribution destination servers are determined on a per-request basis, the distribution logic has to be executed at a very high frequency, which requires a large overhead. Thus, it is difficult to operate a large amount of requests to be processed by multiple servers with low latency.
PACT, described in Non-Patent Literature 3, is intended to operate a CPU core in a high power consumption range and in a low power consumption range, but fails to take into account the power efficiency in each range, and thus fails to perform operations at an operation point optimal with respect to the resource use rate.

The distribution device 1 of the present invention is characterized in that:
the analysis data storage part 12 creates an increase-permitted range indicative of a range of a first allocation quantity such that the power efficiency is improved by increasing an allocation quantity to be greater than the first allocation quantity and includes the increase-permitted range in the ratio determination information; and
the request distribution part 11 forms, as the change-permitted group, an increase-permitted group in which an allocation quantity in the increase-permitted range is allocated to each server 3, and when the quantity of received requests 9 increases, distributes its increase additionally to the servers 3 in the increase-permitted group.

With this, creating the increase-permitted range and processing the increase in the quantity of requests makes it possible to make a distribution setting without changing the request arrival rates of other distribution destinations operating with maximum efficiency.

The distribution device 1 of the present invention is characterized in that:
the analysis data storage part 12 creates an decrease-permitted range indicative of a range of a second allocation quantity such that the power efficiency is improved by decreasing an allocation quantity to be less than the second allocation quantity and includes the decrease-permitted range in the ratio determination information; and
the request distribution part 11 forms, as the change-permitted group, a decrease-permitted group in which an allocation quantity in the decrease-permitted range is allocated to each server 3, and when the quantity of received requests 9 decreases, performs distribution so as to remove its decrease from the servers 3 in the decrease-permitted group.

With this, creating the decrease-permitted range and processing the decrease in the quantity of requests makes it possible to make a distribution setting without changing the request arrival rates of other distribution destinations operating with maximum efficiency.

The distribution device 1 of the present invention is characterized in that the request distribution part 11, when determining the distribution ratio for distributing the received requests 9 among the servers 3, causes a server 3 to which no received request 9 is allocated to transition to the power saving mode.

With this, the distribution device 1 is capable of improving the power efficiency of the entire system.

The load distribution system 100 of the present invention is a load distribution system including the distribution device 1 according to any one of claims 1 to 4, and an analysis device 2, characterized in that:
the analysis device 2 includes a data collecting part 21 and a data analysis part 23;
the data collecting part 21, based on the number of requests processed by each server 3 and power consumption required for processing the requests, collects power characteristic information of each server 3, the power characteristic information indicative of power efficiency with respect to the number of requests; and
the data analysis part 23, based on the collected power characteristic information of each server 3, obtains information indicative of power efficiency in processing each allocation share of the requests 9, the information including a quantity of received requests 9 to be allocated that results in a peak value of the power efficiency, and causes the analysis data storage part 12 to store the obtained result as the ratio determination information.

With this, the load distribution system 100 is capable of obtaining the ratio determination information with high accuracy by actually measuring the power characteristic information of each server 3. Thus, the accuracy of the distribution ratio for distributing the received requests 9 among the servers 3 is improved.

### REFERENCE SIGNS LIST

1 Distribution device (load distribution device)
2 Analysis device
3 Server
9 Received request
11 Request distribution part (distribution part)
12 Analysis data storage part (information storage part)
21 Data collecting part
22 Collected data storage part
23 Data analysis part
31 Request processing part
100 Load distribution system

1-7. (canceled)

8. A load distribution device comprising:
an information storage part; and
a distribution part,
wherein the information storage part includes one or more processors and is configured to store, as ratio determination information for determining a distribution ratio for distributing a plurality of requests among a plurality of request processing parts, power efficiency information indicative of power efficiency in processing each allocation share of the plurality of requests, the power efficiency information including a quantity of requests to be allocated that results in a peak value of the power efficiency; and
wherein the distribution part includes one or more processors and is configured to, based on the ratio determination information read from the information storage part:
form a maximum efficiency group of request processing parts and a change-permitted group of request processing parts, each of the maximum efficiency group of request processing parts being assigned the quantity of requests to be allocated that results in the peak value of the power efficiency, each of the change-permitted group of request processing parts being assigned a quantity of requests that fails to result in the peak value of the power efficiency;
determine the distribution ratio for distributing the plurality of requests among the plurality of request processing parts in such a manner that, for each of the plurality of request processing parts, an allocation share to be allocated to the request processing part is determined based on the group to which the request processing part belongs; and
after performing distribution among the plurality of request processing parts with the determined distribution ratio, when a quantity of the plurality of requests varies by a variation quantity, reflect the variation quantity to the quantities of the requests allocated to the request processing parts belonging to the change-permitted group.

9. The load distribution device according to claim 8,
wherein the information storage part is further configured to create an increase-permitted range indicative of a range of a first allocation quantity such that the power efficiency is improved by increasing a quantity of an allocation share of the plurality of requests to be greater than the first allocation quantity and to include the increase-permitted range in the ratio determination information, and
wherein the distribution part is further configured to form, as the change-permitted group, an increase-permitted group of request processing parts to each of which a quantity of requests in the increase-permitted range is allocated, and when the quantity of the plurality of requests increases by an increase quantity, distributes the increase quantity additionally to the request processing parts belonging to the increase-permitted group.

10. The load distribution device according to claim 8,
wherein the information storage part is further configured to create a decrease-permitted range indicative of a range of a second allocation quantity such that the power efficiency is improved by decreasing a quantity of an allocation share of the plurality of requests to be less than the second allocation quantity and to include the decrease-permitted range in the ratio determination information, and
wherein the distribution part is further configured to form, as the change-permitted group, a decrease-permitted group of request processing parts to each of which a quantity of requests in the decrease-permitted range is allocated, and when the quantity of the plurality of requests decreases by a decrease quantity, perform distribution so as to remove the decrease quantity from the quantities of the requests allocated to the request processing parts belonging to the decrease-permitted group.

11. The load distribution device according to claim 8,
wherein the distribution part is further configured to, when determining the distribution ratio for distributing the plurality of requests among the plurality of request processing parts, cause, of the plurality of request processing parts, a request processing part to which none of the plurality of requests is allocated to transition to a power saving mode.

12. A load distribution system comprising: the load distribution device according to claim 1; and an analysis device,
wherein the analysis device comprises a data collecting part and a data analysis part,
wherein the data collecting part includes one or more processors and is configured to, for each of the plurality of request processing parts, based on a number of requests processed by the request processing part and power consumption required for processing the requests, collects power characteristic information of the request processing part, the power characteristic information indicative of power efficiency with respect to the number of requests, and
wherein the data analysis part includes one or more processors and is configured to, for each of the plurality of request processing parts, based on the collected power characteristic information of the request processing part, obtain the power efficiency information and cause the information storage part to store the obtained power efficiency information as the ratio determination information.

13. A load distribution method to be performed by a load distribution device comprising an information storage part and a distribution part, the distribution part including one or more processors, the information storage part including one or more processors and configured to store, as ratio determination information for determining a distribution ratio for distributing a plurality of requests among a plurality of request processing parts, power efficiency information indicative of power efficiency in processing each allocation share of the plurality of requests, the power efficiency information including a quantity of requests to be allocated that results in a peak value of the power efficiency, the load distribution method comprising steps of, by the distribution part, based on the ratio determination information read from the information storage part:
forming a maximum efficiency group of request processing parts and a change-permitted group of request processing parts, each of the maximum efficiency group of request processing parts being assigned the quantity of requests to be allocated that results in the peak value of the power efficiency, each of the change-permitted group of request processing parts being assigned a quantity of requests that fails to result in the peak value of the power efficiency;
determining the distribution ratio for distributing the plurality of requests among the plurality of request processing parts in such a manner that, for each of the plurality of request processing parts, an allocation share to be allocated to the request processing part is determined based on the group to which the request processing part belongs; and
after performing distribution among the plurality of request processing parts with the determined distribution ratio, when a quantity of the plurality of requests varies by a variation quantity, reflecting the variation quantity to the quantities of the requests allocated to the request processing parts belonging to the change-permitted group.

14. A non-transitory computer-readable medium storing a computer program for causing a computer to function as the load distribution device according to claim 8.
